(19) United States
(12) Patent Application Publication
(10) Pub. No.: US 2001/0032585 A1
(43) Pub. Date: Oct. 25, 2001

(54) Process for the application of format parts upon a transfer roller for the application of a correctly formatted adhesive substance application

(76) Inventors: Uwe Koehn, Osnabrueck (DE); Thomas Knoke, Bielefeld (DE); Gerd Wockenfuss, Lengerich (DE)

Correspondence Address: JACOBSON HOLMAN PLLC, 400 SEVENTH STREET N.W., SUITE 600, WASHINGTON, DC, 20004, US

(21) Appl. No.: 09/832,109

(22) Filed: Apr. 11, 2001

(30) Foreign Application Priority Data
Apr. 19, 2000 (DE) 100 19 491.5

(51) Int. Cl. B05C 5/00

(52) U.S. Cl. 118/304; 118/319

(57) ABSTRACT

From an adhesive substance application device, correctly formatted adhesive substance applications are applied on a continually conveyed web or on continually conveyed objects by means of a transfer roller that is provided with corresponding format parts. In order to be able to provide the transfer roller in a simple manner with accurately contoured format parts or blocks, the latter are applied or sprayed on the the transfer roller in the form of a hardenable liquid.

This invention relates to a process for the application of format parts upon a transfer roller of an adhesive substance application device for the application of a correctly formatted adhesive substance application upon a continually conveyed web or continually conveyed object.

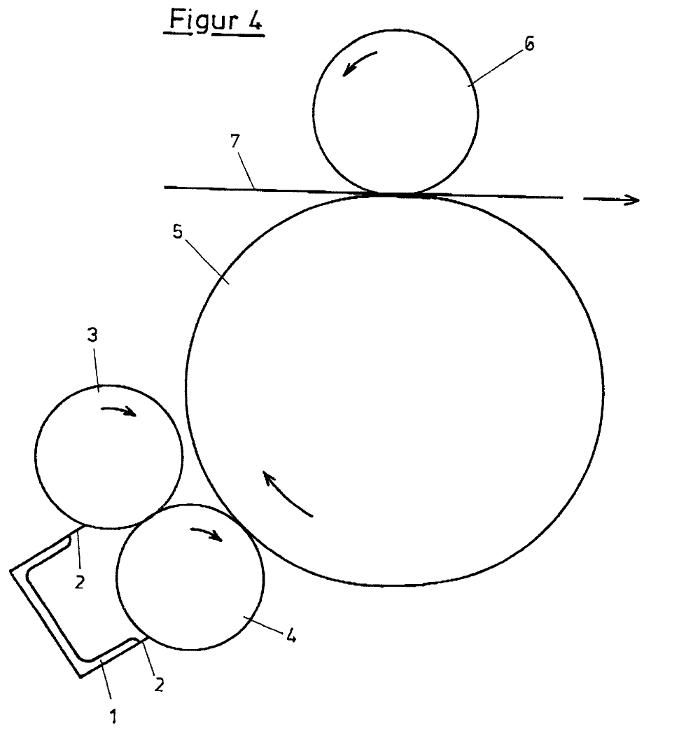

An adhesive substance application device of this kind is known, for instance, from DE 196 34 594 A1 and will be briefly explained with reference to FIG. 4 in the drawing:

The adhesive substance application device consists of an adhesive substance chamber that is retained in the machine frame, not shown, with a perpendicularly positioned U-shaped housing 1 that on its underside is sealed by a bottom plate, not shown. The vertical edges of housing 1 are provided with sealing strips 2 that are placed against adhesive substance rollers 3, 4, which are positioned in the machine frame and that are driven so as to rotate in the direction of the arrows. From the adhesive substance roller 4, the adhesive substance is transferred to format parts or blocks that are arranged in a manner not illustrated upon the circumference of transfer roller 5. These format parts consist of elastomeric material, for example, and were fastened, for example, glued, upon the casing of the transfer roller. Between transfer roller 5 and a counterpressure roller 6, runs a paper web 7 or also a plastic web that is provided with properly formatted adhesive substance applications from the transfer roller.

The arrangement of the adhesive substance application device shown in FIG. 4 is comparatively expensive because the fitting format parts must be made and held in readiness for each glue application and must be fastened upon transfer roller 5. Usually, the format parts or blocks are cut out of rubber parts, for example, rubber plates, which is a laborious and time-consuming job.

The object of the invention therefore is to propose a process of the initially described kind according to which the transfer rollers can be provided in a simple manner with accurately contoured format parts or blocks.

This problem is solved according to the invention in that the format part or the format parts are applied upon or sprayed upon the transfer roller in the form of a hardenable [thermosetting] liquid.

According to the invention-based process, the format parts or blocks are applied or sprayed in liquid form essentially in a correctly formatted manner upon the transfer roller so that after hardening, they will have the required consistency and/or elasticity.

Preferably, the liquid is a hardenable [thermosetting] plastic substance that is offered on the market in a liquid form.

In a practical manner, the liquid is a hardenable plastic substance that consists of two components and both of whose components are mixed directly with each other prior to being sprayed on or spread on.

The liquid can also harden to form a foamed synthetic substance.

Preferably, the liquid hardens to become an elastic synthetic substance or to become a plastic substance with elasto-plastic properties.

To speed up the hardening process of the liquid, the liquid that is spread on or sprayed on can be heated for hardening purposes.

The surface of the applied synthetic substance is profiled in a practical manner with a roller that is pressed on. The profiling roller here can be provided with corresponding ribbing or screening that will profile the surfaces of the format parts in such a way that the synthetic substance that is to be transferred will adhere well and will be well transferred.

The profiling roller is heated in a practical manner.

The liquid cannot always be applied or sprayed upon in so accurate a manner that the hardened format parts will correspond to the desired contour; therefore, a further feature of the invention provides that the format parts be countersunk in a correctly contoured manner. The milling cutter can be controlled by a control device.

The liquid is preferably sprayed on through a controlled nozzle.

After finishing an order, one can use a controlled milling cutter to mill off the existing format parts from the transfer roller so that the latter may be prepared for a new order with different format parts.

According to a further development of the invention, it is provided that the synthetic substance be applied or sprayed upon a carrier or a carrying foil that is retained on the transfer roller and that the order be processed in a correctly contoured fashion in the manner described.

Exemplary embodiments of the invention will be described in greater detail below with reference to the drawing. Here:

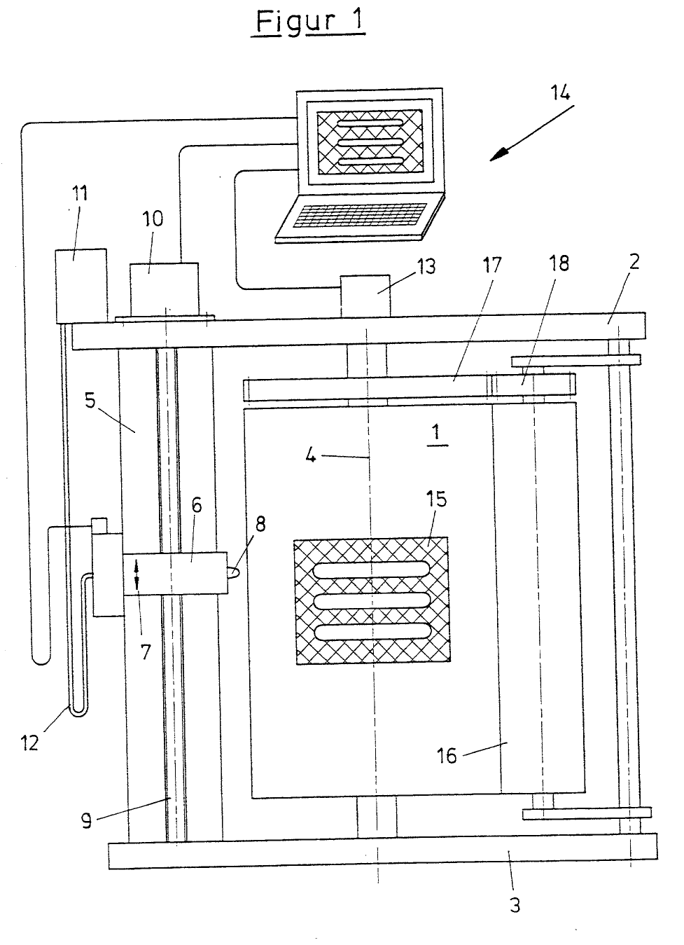

FIG. 1 is a device for spraying on format parts upon a transfer roller in the form of a hardenable liquid in a diagrammatic view.

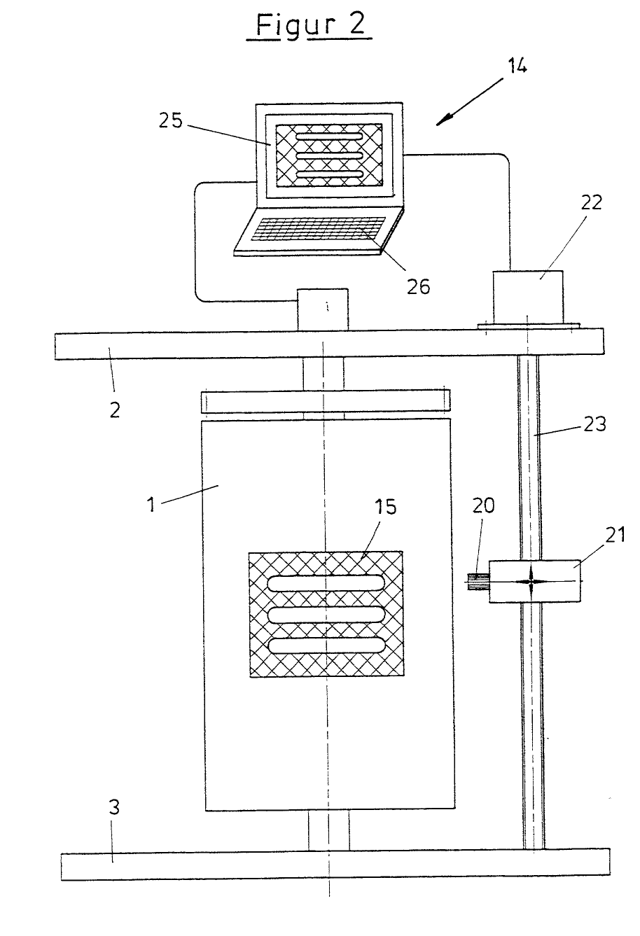

FIG. 2 shows a device for the correctly contoured milling of a format part applied upon a transfer roller in the form of a hardenable liquid presented in a diagrammatic view and

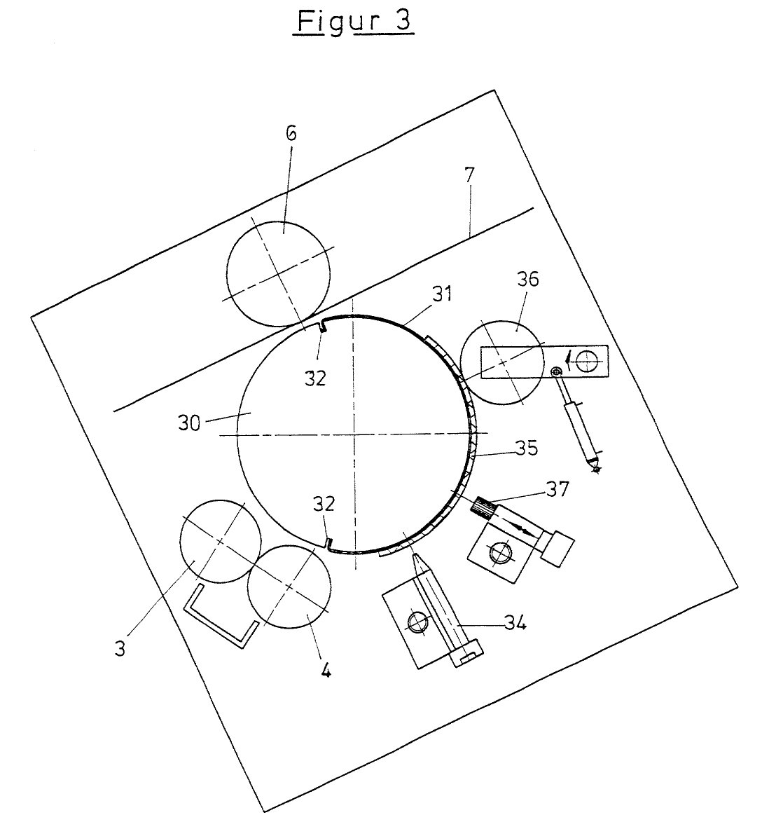

FIG. 3 shows a device for the application of format parts upon a carrier foil attached to a transfer roller presented in a diagrammatic view and

FIG. 4 shows a known adhesive substance application device presented in a diagrammatic view.

FIG. 1 is a diagram illustrating a device for the application of format parts in liquid form upon a transfer roller of an adhesive substance application device. The transfer roller 1 is rotatably positioned in a machine frame, which has side parts 2, 3 that are connected with each other by crossbars. In a guide that runs parallel to the axis 4 of the transfer roller and that belongs to a carrier 5, which connects side parts 2, 3 with each other, a sled 6 is guided so that it can be moved back and forth in the direction of double arrow 7, which sled carries a spray nozzle 6 for the application of a liquid plastic substance upon transfer roller 1. For back-and-forth movement, sled 8 [sic] is provided with a spindle nut that passes through the spindle 9 that is positioned in side parts 2, 3. Spindle 9 is driven by a controlled electric motor 10 that drives the spindle in both directions of rotation. The liquid plastic substance is supplied to spray nozzle 9 via a pump subassembly 11 and a hose 12. Spray nozzle 8 is controlled here by a magnetic valve.

Transfer roller 1, which is suspended in the frame for the purpose of coating it with a correctly formatted application, can be drive by a controlled electric motor 13 in both directions of rotation.

Motors 10, 13, pump subassembly 11 and the magnetic valve that controls spray nozzle 8 are controlled by a control device in the exemplary embodiment illustrated by a laptop 14. The format of the format parts to be sprayed upon transfer roller 1 is put into the electronic control device that will usually consist of a microcomputer. The electronic control device then controls the motors 10, 13, pump subassembly 11 and the magnetic valve of spray nozzle 8 in such a way that form at part 15 is sprayed in the most correctly contoured fashion, in other words, corresponding to the desired shape upon transfer roller 1.

The moment format part or format parts 15 have been sprayed upon transfer roller 1, the surface of format part or format parts 15 is structured. For this purpose, there is provided a profiling or structuring roller 16 that is also positioned in the machine frame and which roller 16 is driven by a gear wheel 17 that is wedged upon the shaft of the transmission roller and that engages a gear wheel 18 of the profiling roller 16. Profiling roller 16 is provided with a corresponding ribbing or screening pattern that structures the surface of the applied format parts 15 the moment the liquid plastic substance has hardened to the point where it has a consistency that permits the desired structuring of the surface.

Profiling roller 16 can be set against the transfer roller 1 in a manner not shown and can be edged away from that transfer roller.

The desired contour and circumferential shape of the format parts will not be achievable only by spraying the plastic substance on; therefore, after the plastic has hardened, the format parts 15 are milled upon the desired mold in a correctly contoured and accurately formatted manner. For this purpose, the device is provided in the manner shown in FIG. 2 with a milling cutter 20 that is arranged in a sled 21, which can be run back and forth by means of a control motor 22 and a spindle 23 between side parts 1. Furthermore, milling cutter 20 can be set in a radial direction against transfer roller 1 and can be edged away from the latter. Sled 21 that carries milling cutter 20 is guided in the usual manner in a guide, not shown.

Both spray nozzle 8 and milling cutter 20 are controlled in a correctly formatted manner by means of an electronic control unit 14 in the exemplary embodiment illustrated here by means of a laptop 14.

Milling cutter 20 is so controlled that it will cut the form of the applied format part 15 out in the desired shape. In order not to damage the casing of transfer roller 1, milling cutter 20 can be set against said roller only so far that it will just about not touch the casing of the roller.

The pattern of the format parts, which is to be applied and which must then be milled out, can be displayed on the indication device 25 of the electronic control unit and can also be read out and selected from a memory via keyboard 26.

In the exemplary embodiment according to FIG. 3, a carrier foil 31 is mounted in the usual fashion on transfer roller 30; said carrier foil 31 is provided with down-angled side edges that in the usual manner are fixed in axial grooves 32 of transfer roller 30. A format part 35 is then sprayed upon carrier foil 31 in the described manner by means of a controlled spray nozzle 34 in the most accurately contoured manner; after adequate hardening, said format part 35 is structured along its surface by a profiling roller 36 and is cut in a correctly contoured fashion by a controlled milling cutter 37.

1. Process for the application of format parts upon a transfer roller of an adhesive substance application device for the application of a correctly formatted adhesive substance application upon a continually conveyed web or continually conveyed objects,
characterized in
format part (15) or the format parts are applied or sprayed upon the transfer roller (1) in the form of a hardenable liquid.

2. Process according to claim 1, characterized in that the liquid is a hardenable plastic substance.

3. Process according to claim 2, characterized in that the liquid is a hardenable plastic substance consisting of two components.

4. Process according to one of claims 1 to 3, characterized in that the liquid hardens to form a foamed plastic substance.

5. Process according to one of claim s 1 to 4, characterized in that the liquid hardens to form an elastic or elasto-plastic synthetic substance.

6. Process according to one of claims 1 to 5, characterized in that the applied or sprayed-on liquid is heated for hardening purposes.

7. Process according to one of claims 1 to 6, characterized in that the surface of the plastic substance is profiled with a roller (16) that is pressed on.

8. Process according to claim 7, characterized in that the profiling roller (16) is heated.

9. Process according to one of claims 1 to 8, characterized in that the format parts (15) are milled out in a correctly contoured fashion.

10. Process according to claim 9, characterized in that the milling cutter is controlled by a control device (14).

11. Process according to one of claims 1 to 10, characterized in that the liquid is sprayed on through a controlled nozzle (8).

12. Process according to one of claims 1 to 11, characterized in that the existing format parts (15) are milled off with the help of a controlled milling cutter (20) from the transfer roller (1) in order to prepare the latter for a new order with altered format parts.

13. Process according to one of claims 1 to 12, characterized in that the synthetic substance is applied or sprayed upon a carrier or a carrier foil (31) that is retained on the transfer roller (1) and is processed in a correctly contoured manner.
